(19) United States
(12) Patent Application Publication
(10) Pub. No.: US 2026/0129147 A1
(43) Pub. Date: May 7, 2026

(54) PREEMPTIVELY ESTABLISHED LIVE CONNECTIONS FOR REAL-TIME TRANSCRIPTIONS IN VIRTUAL MEETINGS

(71) Applicant: ORACLE INTERNATIONAL CORPORATION, Redwood Shores, CA (US)

(72) Inventors: Prabhutva AGRAWAL, Madhya Pradesh (IN); Phanindra Vittal Rao MANKALE, Bengaluru (IN)

(21) Appl. No.: 18/938,385

(22) Filed: Nov. 6, 2024

(51) Int. Cl. H04N 7/15; G10L 15/26; H04N 7/14

(52) U.S. Cl. CPC H04N 7/157; G10L 15/26; H04N 7/147; H04N 7/152

(57) ABSTRACT

Systems, methods, and other embodiments associated with efficient allocation of live connections for real-time transcriptions of virtual meetings are described. In one embodiment, an example method includes preemptively establishing a set of live connections to an automatic speech recognition service that are available for use, and fewer than the participants of a virtual meeting. In response to a participant of the virtual meeting becoming active, the method dedicate one WebSocket connection from the set of WebSocket connections to real-time transcription of an individual audio stream from the participant. The method labels transcription results received back through the one live connection with a username of the participant. And, the method injects the labeled transcription results back into the virtual meeting for display in a user interface.

### BACKGROUND

Virtual meeting and collaboration services allow a plurality of participants to communicate and collaborate remotely through video, audio, and chat, facilitating online meetings, presentations, and teamwork. Automated speech recognition services may be used to convert audio of speech into text. Live connections such as WebSocket connections are highly resource intensive, and take up substantial compute resources, such as allocated memory, to maintain.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a transcription management system that is associated with efficient, autonomous provisioning of preemptively established live connections for real-time transcription of speech in virtual meetings.

FIG. 2A illustrates one embodiment of a transcription management method that is associated with efficient, autonomous provisioning of preemptively established live connections for real-time transcription of speech in virtual meetings.

FIG. 2B illustrates one embodiment of a connection dedication step in which some sub-steps of dedication of the connection are indicated.

FIG. 3 illustrates a data flow diagram for an example real-time meeting transcription system that is associated with efficient, autonomous provisioning of preemptively established live connections for real-time transcription of speech in virtual meetings.

FIG. 4 illustrates one embodiment of a transcription socket manager that is associated with efficient, autonomous provisioning of preemptively established live connections for real-time transcription of speech in virtual meetings.

FIG. 5 illustrates one embodiment of a WebSocket handler that is associated with efficient, autonomous provisioning of preemptively established live connections for real-time transcription of speech in virtual meetings.

FIG. 6 illustrates one embodiment of a UserID handler that is associated with efficient, autonomous provisioning of preemptively established live connections for real-time transcription of speech in virtual meetings.

FIG. 7 illustrates an embodiment of a computing system configured with the example systems and/or methods disclosed.

### DETAILED DESCRIPTION

Systems, methods, and other embodiments are described herein that provide for efficient allocation of preemptively established live connections for real-time transcriptions in virtual meetings. In one embodiment, a transcription management system actively allocates persistent live connections that have been preemptively established with an artificial intelligence (AI)-based transcription service (such as an automatic speech recognition (ASR) service) to those individual audio streams from a virtual meeting that are associated with participants that are active. For example, the transcription management system intelligently provisions a block of pre-established WebSocket connections to the AI transcription service on an as-needed basis to process audio streams of participants who are speaking. In this way, the transcription management system dynamically interconnects an individual audio stream for an active participant to a session of an AI transcription service on an as-needed basis and maintains unambiguous associations between participant identity and transcript.

Various embodiments of the transcription management system may provide one or more improvements to the technology of automated speech transcription. One improvement may be that the transcription management system enables the use of substantially fewer live connections than the number of participants in the virtual meeting, thereby substantially reducing the compute resources (e.g., memory and network bandwidth) consumed by the live connections to the AI transcription service. One improvement may be that the transcription management system enables independent (dedicated) transcription of speech from individual, active participants without creating and assigning a dedicated live connection for each participant. One improvement may be that the transcription management system ensures that the audio stream of one participant is transcribed without interference by the audio streams of other participants, thereby increasing transcription accuracy. One improvement may be that the transcription management system largely eliminates wait time for transcription (or captioning) to start for a newly active meeting participant because the live connection allocated to the participant is already established. One improvement may be that the real-time transcription service unambiguously associates an incoming audio stream with generated transcription, thereby identifying the speaker of a transcription with full accuracy. One improvement may be that the transcription management system automatically scales a number of connections as participants become active or inactive over the course of a meeting.

### Definitions

As used herein, the term “active” with reference to a participant, user, or userID refers to a client of a virtual meeting (or collaboration) service that is connected to a virtual meeting (or collaboration session) and which is delivering an unmuted audio stream.

As used herein, the term “inactive” reference to a participant, user, or userID refers to a client of a virtual meeting (or collaboration) service that is connected to a virtual meeting (or collaboration session) and which is delivering a muted audio stream, or not delivering an audio stream at all.

As used herein, the term “virtual meeting service” refers to software platforms or applications that enable participants to conduct virtual meetings and collaborate over a network (such as the Internet) in real time from discrete physical locations. A virtual meeting service typically provides audio conferencing. A virtual meeting service may also provide a range of other communication tools, such as video conferencing, text chat, and screen sharing.

As used herein, the term “real-time” refers to the ability to transcribe speech into text as the speech is being spoken, with a low latency or delay that is small enough to appear nearly immediate to a user. For example, the delay between speech and transcription in real-time can be under a few seconds, or, for even tighter correspondence between speaking and transcription the delay can be under a few hundred milliseconds.

As used herein, the term “diarization” refers to a process of identifying and distinguishing between different speakers in audio.

No action or function described or claimed herein is performed by the human mind. An interpretation that any action or function can be performed in the human mind is inconsistent with and contrary to this disclosure.

### Example Transcription Management System

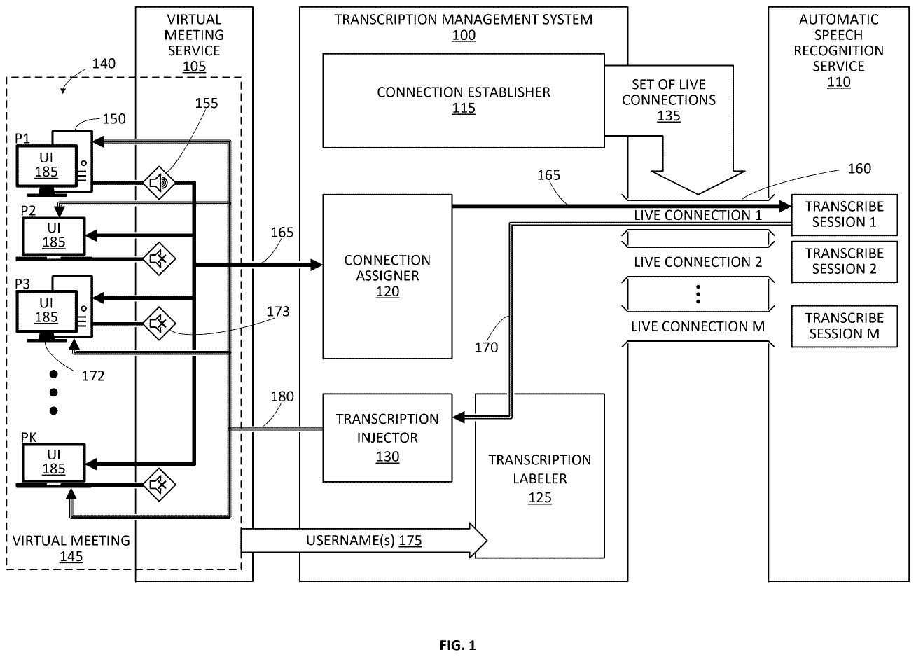

FIG. 1 illustrates one embodiment of a transcription management system 100 that is associated with efficient, autonomous provisioning of preemptively established live connections for real-time transcription of speech in virtual meetings. In one embodiment, transcription management system 100 manages connections of individual audio streams from a virtual meeting service 105 to an automatic speech recognition (ASR) service 110. And, in one embodiment, transcription management system 100 manages the return and diarization of transcription results from the ASR service 110 to the virtual meeting service 105. Transcription management system 100 includes a connection establisher 115, a connection assigner 120, a transcription labeler 125, and a transcription injector 130. In one embodiment, the components of transcription management system 100, virtual meeting service 105, and ASR service 110 intercommunicate, for example by electronic messages, as discussed below under the heading “Cloud or Enterprise Embodiments”.

In one embodiment, connection establisher 115 is configured to preemptively establish a set of live connections 135 to the ASR service 110 that are available or ready for use. The set of live connections 135 includes fewer live connections than a total K of participants 140 in a virtual meeting 145.

In one embodiment, connection assigner 120 is configured to, in response to a participant 150 (participant P1) of the virtual meeting 145 becoming active 155 (unmuted), dedicate one live connection 160 from the set of live connections 135 to real-time transcription of an individual audio stream 165 from the participant 150. Individual live connections connect to a dedicated, individual session of ASR transcription, which may be identified by a session ID. ASR service 110 converts the individual audio stream 165 into transcription results 170 in real-time. For example, the connection assigner 120 may (1) associate a session ID of the one live connection 160 with a user ID of the participant 150, and (2) send an individual audio stream 165 of the participant 150 to the ASR service 110 through the one live connection 160 to cause the ASR service 110 to transcribe speech (by the participant 150) from the individual audio stream 165 into transcription results 170 in real-time. Additional audio streams of other participants than participant 150 are not sent through the one live connection 160. Note that additional audio streams, such as an additional audio stream of an additional participant 172 (participant P3) may be muted 173, and is disregarded by connection assigner 120 until the additional audio stream is unmuted.

In one embodiment, transcription labeler 125 is configured to, in real-time, label the transcription results 170 received back through the one live connection 160 with a username 175 of the participant 150, thereby generating labeled transcription results 180. In one embodiment, transcription injector 130 is configured to, in real-time, inject the labeled transcription results 180 back into the virtual meeting for display in a user interface 185 of the virtual meeting 145. User interface 185 is configured to display the labeled transcription results 180 in real-time as the transcribed speech is spoken by the participant 150.

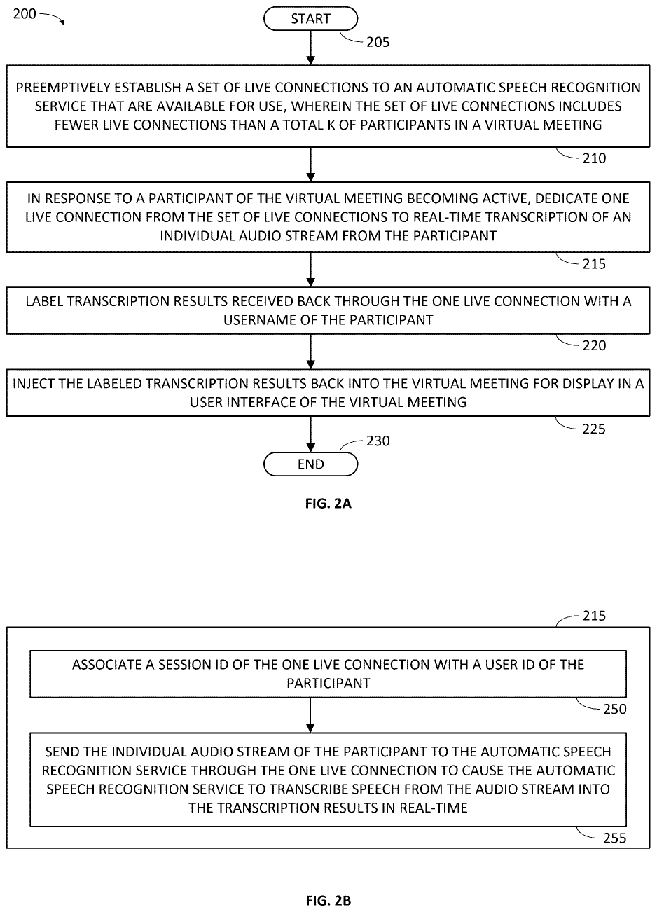

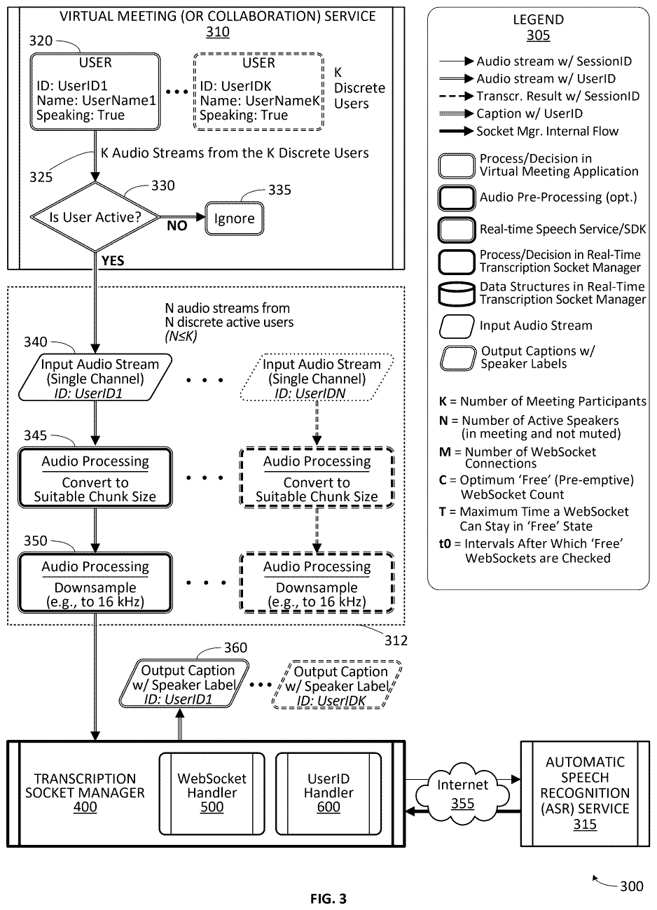

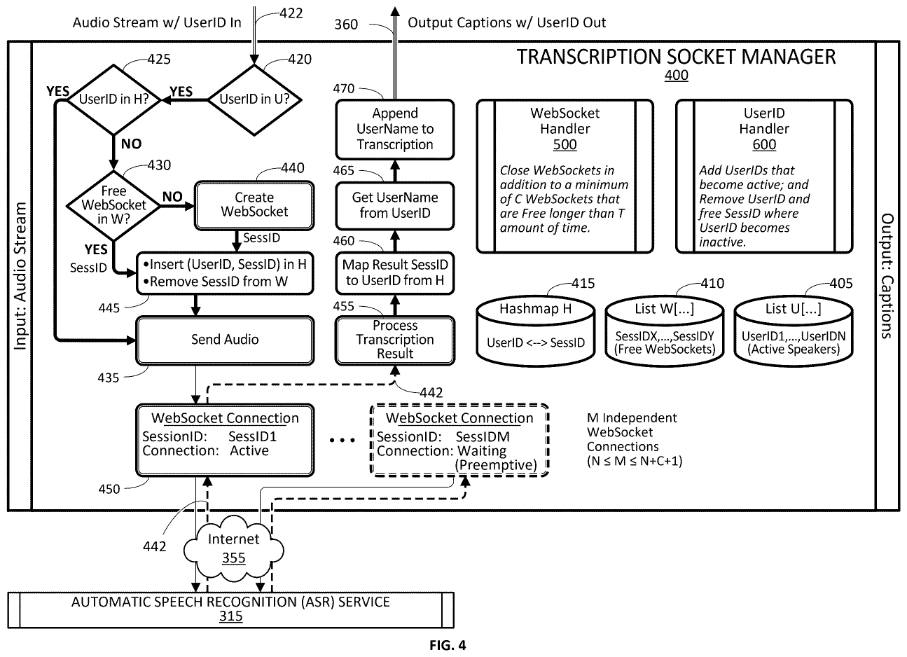

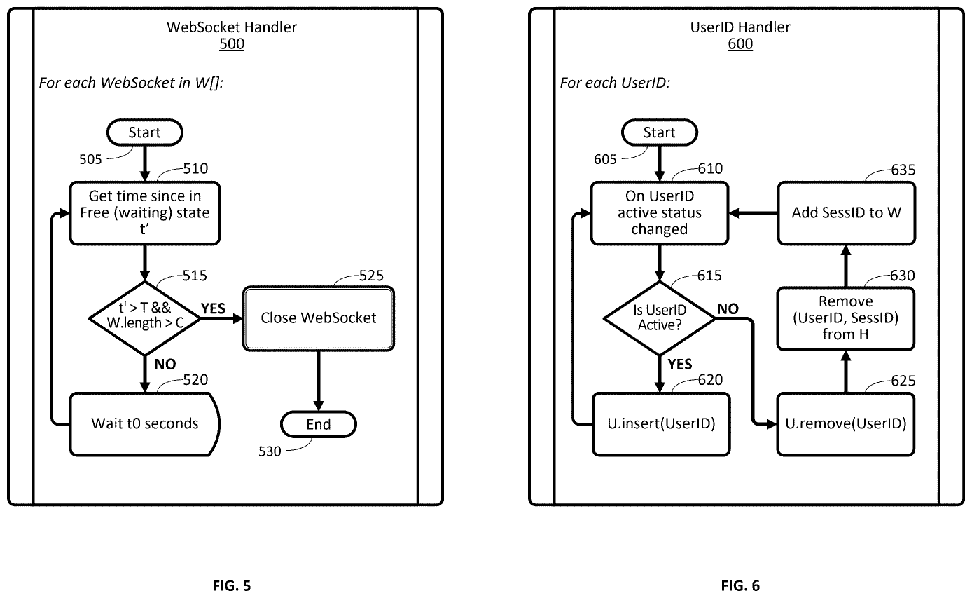

Further details regarding the transcription management system 100 are presented herein. In one embodiment, operations of transcription management system 100 will be described with reference to transcription management method 200 of FIG. 2. In one embodiment, one detailed example implementation of transcription management system 100 will be described with reference to process diagrams for real-time meeting transcription system 300 of FIG. 3, transcription socket manager 400 of FIG. 4., WebSocket Handler 500 of FIG. 5, and user ID handler 600 of FIG. 6.

### Example Transcription Management Method

FIG. 2A illustrates one embodiment of a transcription management method 200 that is associated with efficient, autonomous provisioning of preemptively established live connections for real-time transcription of speech in virtual meetings. Transcription management method 200 is one example method for dynamically assigning individual audio streams to pre-established live connections to individual transcription sessions of an ASR service based on whether or not a participant is unmuted.

In one embodiment, as a general overview, transcription management method 200 initially sets up a pool of pre-emptively established live connections to sessions of an ASR service. Transcription management method 200 detects when a participant of a virtual meeting becomes unmuted. In response to the unmuting, transcription management method 200 assigns one of the live connections (and associated individual ASR session) for dedicated use by the unmuted participant. And, in response to the unmuting, transcription management method 200 also sends an isolated audio stream or track produced by the participant through the assigned live connection for transcription by the ASR service. As transcriptions results are received back through the assigned live connection, transcription management method 200 adds the username of the participant to the text of the transcription results. Transcription management method 200 continually transfers the labeled transcription results back into the virtual meeting for display.

In one embodiment, transcription management method 200 initiates at START block 205 in response transcription management system 100 determining that one or more conditions or events have been detected or have occurred, including, but not limited to: (1) transcription management system 100 has received an instruction to transcribe a virtual meeting; (2) transcription management system 100 is joining a virtual meeting; (3) a number of previously inactive participants of a virtual meeting have become active that is in excess of a count of C live connections that are available for use; (4) the number of live connections that are available for use has fallen below count C; (5) an instruction to perform transcription management method 200 has been received; (6) a user or administrator has initiated transcription management method 200; (7) it is currently a time at which transcription management method 200 is scheduled to be run; or (8) transcription management method 200 should commence in response to satisfaction of some other condition. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of transcription management system 100 executes transcription management method 200. In one embodiment, at START block 205, transcription management system 100 configures compute resources for performing transcription management method 200. (1) Transcription management system 100 provisions (i.e., allocates and initializes) resources of the computing system that are used by transcription management system 100, such as processor, memory and storage (for example, for executing components of transcription management system 100 or transcription socket manager 400). (2) Transcription management system 100 establishes access to one or more networks for the resources, such as access to (a) internal networks for communication among components of the transcription management system 100 or transcription socket manager 400 and (b) external networks for communication with other computing systems (for example, virtual meeting service 105 and ASR service 110). (3) Transcription management system 100 connects to data sources (such as databases, data stores, file systems, and cloud storage) used by the transcription management method 200. And, (4) transcription management system 100 configures the computing system with system settings, software dependencies and libraries, and modules for the components of transcription management system 100 or transcription socket manager 400. Following initiation at START block 205, transcription management method 200 proceeds to block 210.

At block 210, transcription management method 200 preemptively establishes a set of live connections to an automatic speech recognition service that are available for immediate use. The set of live connections includes fewer live connections than a total K of participants in a virtual meeting. Transcription management method 200 preemptively establishes the set of live connections such that the set of live connections to the ASR service are set up ahead of a time that the connection is called for (e.g., before a participant is in an unmute status or state). The preemptively established connections are thus ready to begin transcription right away, without delay caused by opening and configuring the connection. Otherwise (in prior systems), when a participant unmutes and starts talking, the first few words spoken by the participant may be missed and not transcribed while the system goes through the process of opening and configuring a live connection to the ASR service for the participant.

In one embodiment, the preemptively established live connections are available for immediate use such that the live connection is ready to accept input streams and commence transcription in real-time or near real-time. For example, the live connections may be preemptively made ready for immediate use by being initiated and held in an open, configured state awaiting assignment to an input audio stream. Example steps for preemptive provisioning of live connections to ASR service 310 follow.

Transcription management method 200 initializes the meeting context by: (1) retrieving information about the virtual meeting, including the total number of participants (K) and their associated user IDs and usernames from the virtual meeting service 105, for example through a webhook event or API request for these participant details; and (2) obtaining connection credentials and configuration details for the ASR service 110, such as API keys and session setup parameters.

In one embodiment, transcription management method 200 determines values for the total number of participants K and the number of available live connections C. For example, transcription management system 200 retrieves a value for K from virtual meeting service 105. In one embodiment, the total number of participants K in the virtual meeting may be retrieved by counting or tallying the participants in a list of the participant details. Or, the total number of participants K in the virtual meeting may be obtained directly from the virtual meeting service through a webhook event or API request.

Transcription management method 200 then determines the pre-defined number (C) of live connections to be pre-emptively established. For example, C is a baseline number of participants that might be expected to become active relatively simultaneously at any given time. This is fewer than all participants K (C<K). C may be based on historical data or expected participant activity. The value of C may be derived from the value of K based on a fixed ratio or logarithmic proportion of participants, for example, a pre-selected ratio of participants who might reasonably be permitted to be speaking at once in a meeting having K participants.

Transcription management method 200 sets up C live connections (such as WebSocket connections) to the ASR service 110. For the C live connections, transcription management method 200 preemptively establishes the live connection by: (1) initializing a live connection client (such as a WebSocket client); (2) establishing a live connection to an endpoint of the ASR service 110; (3) sending initial configuration data used by the ASR service 110 (such as language settings, audio format, sampling rate, and authentication information); and (4) obtaining a session ID for the connection from a confirmation from the ASR service 110 that the live connection has been successfully established. Because the C live connections are preemptively established to an already-running session of the ASR service 110, transcription of participant speech can commence upon assignment of the audio stream of the participant to the live connection, avoiding delay for initiating the ASR session.

Transcription management method 200 stores the session IDs for the C live connections in a list W[ . . . ] of available live connections. Inclusion of these connections in the list W[ . . . ] indicates that the connections are ready for immediate use for transcription, meaning that that can be assigned to an incoming audio stream as soon as a participant generating the audio stream becomes active (unmutes).

In one embodiment, the steps of block 210 are performed by connection establisher 115. At the conclusion of block 210, transcription management method 200 has made a pool or set of pre-emptively established live connections ready to immediately commence transcription of an assigned audio stream upon assignment of the audio stream. Connections to the ASR service are thus made available when needed, without over-provisioning for all participants. Processing continues to block 215.

At block 215, in response to a participant of the virtual meeting becoming active, transcription management method 200 dedicates one live connection from the set of live connections to real-time transcription of an individual audio stream from the participant. As soon as a participant starts talking in the virtual meeting, a live connection that is ready and waiting for audio input is assigned to transcribe the speech of the participant. This swaps-in a live connection for transcription in real-time. Because the one live connection is reserved for the transcription of the audio stream of one participant, audio and transcription data for the one participant that passes through the one live connection is not mixed logically with audio and transcription data for other participants. Example steps for dedication of live connections to participant audio tracks follow.

Transcription management method 200 monitors participant activity to detect which participants are active (unmuted) or inactive (muted) at any given time. Transcription management method 200 may continually monitor the mute/unmute status for the participants in the virtual meeting using APIs or Webhooks provided by the virtual meeting service 105. Transcription management method 200 detects when a participant becomes active. Transcription management method 200 tracks which speakers are active, for example by adding the user IDs of active participants to a list U[ . . . ] of active speakers. Transition to the active state triggers a process to begin transcription for a participant.

Referring briefly to FIG. 2B, FIG. 2B illustrates one embodiment of the connection dedication step of block 215, in which some sub-steps of dedication of the connection are indicated. At block 250, transcription management method 200 associates the session ID of one live connection with the user ID of the participant. Transcription management method 200 selects one live connection that is currently free, for example by: (1) accessing the list W[ . . . ] of available live connections that were pre-emptively established with the ASR service 110; (2) retrieving a session ID, such as a next available session ID, from the list W[ . . . ]. (If there are no free connections, transcription management method 200 may automatically establish a new connection to the ASR service.) Transcription management method 200 then associates the audio stream of the isolated audio input of the participant with the one live connection. Transcription management method 200 maps the audio stream of the participant to the one live connection, for example by entering a pair of the user ID of the participant and the session ID of the one live connection into a hashmap H of user ID—session ID associations.

At block 255, transcription management method 200 sends the individual audio stream of the participant to the ASR service 110 through the one live connection. Transcription management method 200 routes the audio stream of the participant through the selected live connection to the ASR service 110 for transcription. For example, transcription management method 200 transmit chunks or frames of the audio stream though the one live connection using a “send” function of the one live connection. Receipt of the audio stream by ASR service 110 causes ASR service 110 to transcribe speech from the audio stream into transcription results in real-time as the audio stream is received. ASR service 110 returns the transcription results that it has generated through the one live connection in real-time as they are produced.

Returning to FIG. 2A, in one embodiment, the steps of block 215 are performed by connection assigner 120. At the conclusion of block 215, transcription management method 200 has provided a substantially immediate launch of transcription service in response to a participant beginning to speak in a virtual meeting. Processing continues to block 220.

At block 220, transcription management method 200, in real-time, labels transcription results received back through the one live connection with a username of the participant. The transcription management method: (1) listens for transcription results through a live connection, (2) identifies which participant's audio is being transcribed based on a mapping the session ID of the connection to the user ID of the participant, (3) retrieves the username of the participant based on their ID, and (4) labels the transcription results with the retrieved username in real-time for accurate diarization. Example steps for labeling of transcription results follow.

While the participant remains active, transcription management method 200 continues to send the audio stream of the participant and receive the transcription results through the one live connection that is dedicated to the participant. Transcription management method 200 continuously listens for and collects the transcription results from the ASR service 110 through the dedicated live connection. The transcription results are transcribed text generated by ASR service 110 from the audio stream. The transcription results may be received incrementally or in chunks into a buffer.

Once a pre-determined amount of text is accumulated, for example, a full buffer, or a number of words, or text covering an amount of time that the participant has spent speaking, the transcription results are labeled with the username of the participant. For example, the accumulated transcription results may be stored as a string. Transcription management method 200 identifies the specific live connection through which the transcription results are coming, for example, by obtaining the session ID for the live connection. The session IDs of various live connections that are dedicated to particular participants are associated with the user IDs of the particular participants in hashmap H (or other data structure). Transcription management method 200 checks hashmap H to look up and retrieve the user ID that is associated with the session ID.

Using the user ID that was paired with the session ID in hashmap H, transcription management method 200 retrieves the username for the participant from a stored list (or other data structure) of participant details. The participant details may be obtained from the virtual meeting service 105, for example through an API of the virtual meeting service or through a Webhook event when the participant joins the virtual meeting.

Transcription management method 200 then applies the username of the participant to the accumulated transcription results. For example, transcription management method 200 prepends the username to the string containing the accumulated transcription results, thereby labeling the transcription results with the username of the participant. The string of transcription results, with username applied as a label, is then stored (for example, in memory) for subsequent transmission back into the virtual meeting.

The cycle of accumulating transcription results delivered through the live connection and labeling them with the username of the participant to whom the live connection is dedicated may be repeated continually for incoming transcription results until the participant becomes inactive or leaves the meeting.

In one embodiment, the steps of block 220 are performed by transcription labeler 125. At the conclusion of block 220, transcription management method 200 has attributed the transcribed text to the speaker that generated the transcribed audio stream. Processing continues to block 225.

At block 225, transcription management method 200, in real-time, injects the labeled transcription results back into the virtual meeting for display in a user interface of the virtual meeting. In short, transcription management method 200 sends the text transcript of the speech of the participant to the virtual meeting service to be shown visually in the virtual meeting. Example steps for injection of the labeled transcription results follow.

As an initial preparatory step, transcription management method 200 obtains an API token or other access credentials for providing captioning to the virtual meeting. For example, transcription management method 200 requests and receives the API token from the virtual meeting service 105. The token includes a URL for a captioning endpoint to which captions (such as the labeled transcription results) may be sent for display in the virtual meeting. Transcription management method 200 establishes a connection to the captioning endpoint for the virtual meeting. The connection may be established as a live connection such as a WebSocket connection, or the connection may be effected by HTTP POST requests.

Transcription management method 200 then transmits the labeled transcription results to the captioning endpoint in real-time, as they are created. The virtual meeting service 105 accepts the labeled transcription results received at the captioning endpoint, and presents the labeled transcription results in a graphical user interface of the virtual meeting. A captioning functionality for the virtual meeting service operates to show the captions to some or all of the participants in real-time, as the captions arrive at the captioning endpoint. For example, the captioning functionality may be the live captions feature in the Zoom virtual meeting service, or the subtitle feature of the Cisco WebEx virtual meeting service. The labeled transcription results may be shown in a video display region of the graphical user interface that shows one or more participants, such as the active participants. For example the labeled transcription results may be presented at or near the bottom of the video display region. Or, the labeled transcription results may be shown in a dedicated captioning region of the graphical interface that shows current or recent captions.

In one embodiment, the steps of block 225 are performed by transcription injector 130. At the conclusion of block 225, transcription management method 200 has caused a transcription by an external ASR service to be displayed in the virtual meeting. Processing continues to END block 230, where transcription management method concludes.

### Example Additional Features of Transcription Management

In one embodiment, transcription management method 200 includes additional steps to determine to connect or disconnect the individual audio stream of the participant through a live connection based on whether the participant is muted or unmuted (for example, as discussed above at block 215 and below with reference to FIGS. 4 and 6). For example, transcription management method 200 monitors a mute/unmute status of the participant to determine when the participant becomes active. In response to the mute/unmute status changing from mute to unmute, transcription management method 200 (1) allocates the one live connection for sole use by the participant and (2) connects the individual audio through the one live connection to an individual session of the automatic speech recognition service. And, in response to the mute/unmute status changing from unmute to mute, transcription management method 200 (1) disconnects the individual audio stream from the one live connection, and (2) deallocates the one live connection back to the set of live connections that are available for use.

In one embodiment, dedicating one live connection from the set of live connections to real-time transcription of an individual audio stream from the participant (as discussed above with reference to block 215) includes steps to effect an exclusive connection to the ASR service for transcribing the isolated audio track of speech by the participant. For example, the transcription management method 200 may (1) associate a session ID of the one live connection with a user ID of the participant; and (2) send the individual audio stream of the participant to the automatic speech recognition service through the one live connection. Sending the individual audio stream through the one live connection causes the automatic speech recognition service to transcribe speech from the audio stream into the transcription results in real-time. Because the one live connection to the ASR service is a live connection, audio streams of other participants are not sent through the one live connection.

In one embodiment, preemptively establishing a set of live connections to the ASR service (as discussed above with reference to block 210, and below with reference to block 440) includes a number of steps to set up the live connections before participants become active (such as by entering an unmuted state). In one embodiment, these steps are performed prior to participants becoming active for one or more (or each) of the live connections in the set of live connections. For example, prior to the participant becoming active, for at least for the one live connection that will be dedicated to the participant, transcription management method 200: (1) connects a client (such as a WebSocket client) to an endpoint (such as a WebSocket endpoint) of the ASR service 110; (2) configures the client to capture the transcription results upon receipt from the automatic speech recognition service; (3) transmits credentials for the client to the automatic speech recognition service; (4) receive a session ID for the one live connection (the session ID denotes an individual session of the ASR service 110 that is accessible through the one live connection; and (5) adds the session ID for the one live connection to a list of session IDs (such as list W [ . . . ] 410) for the set of live connections.

In one embodiment, in response to the participant of the virtual meeting inactive, transcription management method 200 releases the one live connection from dedication to the participant back into the set of live connections that are available for immediate use. For example, the transcription management method 200 may release the one live connection from dedication to the participant back into the set of live connections that are free (or available for use) by: (1) disconnecting the audio stream of the participant from the one live connection so as to no longer direct data traffic of the audio stream through the one live connection; and (2) deallocating the one live connection from association with the participant by (a) removing the association between the User ID of the participant and the Session ID of the individual ASR session reached through the one live connection from hashmap H 415, and (b) making the one live connection available for use (or free) by re-listing the one live connection in list W[ . . . ] 410—the pool of live connections that are on standby and available for use. In this way, unused live connections are returned to a pool of connections to the ASR service that are established and live and allow for rapid initiation of transcription upon assignment. For example, if a participant becomes inactive, transcription management method stops sending the audio stream of the participant through the one live connection, and marks the one live connection as available again for dedication to other participants.

In one embodiment, transcription management method 200 closes live connections that are in excess of a baseline count C of live connections and which have been available for use longer than a threshold amount of time T. In this way, live connections that are unlikely to be used are terminated, thereby freeing up compute resources.

In one embodiment, transcription management method 200 expand the set of live connections to the automatic speech recognition service by preemptively establishing additional live connections when the live connections that are available for use falls to a threshold number. In this way, a minimum number C of live connections to the ASR service are maintained in the pool to ensure that rapid initiation of transcription remains available even when multiple participants are simultaneously active.

In one embodiment, the participant is considered to be “active” when the audio stream of the participant is unmuted. And, the participant is considered to be “inactive” when the audio stream of the participant is muted.

In one embodiment, the live connections to the ASR service are WebSocket connections.

In one embodiment, the transcription management method 200 further joins the transcription management system to the virtual meeting as an additional participant to obtain the individual audio stream that is input by the participant.

In one embodiment, the real-time transcription includes translation from a first human language to a second human language, wherein speech in the individual audio stream is in the first human language, and the transcription results are in the second human language. For example, ASR service 110 may further be configured to perform automatic speech translation (AST), automatically converting the text of the speech from the first, original human language into text of the second, target human language. For example, the audio stream of the participant may include speech in Chinese, and the transcription results may be a translation provided in English. In one embodiment, the transcription results may be further spoken aloud in the virtual meeting using text-to-speech synthesis to achieve a speech-to-speech translation. The speech-to-speech translation may be injected into the virtual meeting on a language interpretation audio channel. For example, the language interpretation audio channel may be made available when the transcription management system 100 joins the virtual meeting as an interpreter.

### Context and Discussion of Real-Time Transcription Management Solution

In one embodiment, the transcription management system 100 includes a real-time transcription socket manager for live captioning of speech. For example, the socket manager allocates WebSockets or other persistent live connections with an ASR service. The ASR service operates in real-time to accept an audio stream of speech from a virtual meeting service as input and return a stream of text transcriptions (also referred to as captions) of the speech. The transcriptions are generated by the ASR service and returned to the virtual meeting service in real-time through the sockets managed by the socket manager. In this way, participants in a virtual meeting are enabled to view the externally-generated transcriptions in real-time, inside the virtual meeting.

In one embodiment, the transcription management system 100 operates as a captioning bot for virtual meeting services. In one embodiment, the transcription management system 100 is integrated with virtual meeting services (such as Zoom). The transcription management system 100 uses the SDKs (software development kit) associated with the virtual meeting service to fetch information about participants and audio from virtual meetings in real-time. The transcription management system 100 gets transcriptions for the audio from the ASR service, and then injects the transcriptions back into a user interface of the virtual meeting service. The ASR service may reside on servers associated with a provider of the ASR service—such as the internal servers of OCI—and not on servers associated with a provider of the virtual meeting service—such as the internal servers of Zoom. The transcription management system 100 may provide transcriptions of a virtual meeting from the ASR service by joining the virtual meeting as a meeting participant. Such integration enables an enterprise solution where highly-accurate and/or domain-specific transcriptions may be desired or required.

In one embodiment, the transcription management system 100 dynamically interconnects individual audio streams and the ASR service based on activity (e.g., speech) of the meeting participants. In one embodiment, the transcription management system 100 ensures that the audio streams of individual participants are transcribed without interference from the audio streams of other participants.

In one embodiment, the transcription management system 100 streams an individual audio stream for each meeting participant through a dedicated WebSocket connection to the ASR service (such as OCI AI Realtime Speech Service). In this way, unambiguous transcription is independently generated for each participant. Moreover, by uniquely mapping the sent audio stream with the generated transcription, the transcription management system 100 can identify the speaker of a transcription with full accuracy. This approach by the transcription management system 100 bypasses any speech captioning which might be done on the server for the virtual meeting, and instead enables meeting participants to use a trusted transcription service, such as their own secured access to OCI AI Realtime Speech. And, this approach by the transcription management system 100 also reduces the wait time for the captioning to start when a new participant joins by pre-emptively creating WebSocket connections which are ready for the new participant. Simultaneously, transcription management system 100 optimizes on the number of concurrent connections used for transcription by intelligently provisioning connections as participants unmute and mute.

In one embodiment, the transcription management system 100 provides several advantageous features. The transcription management system 100 links the voice and identity of a meeting participant with their transcriptions. The transcription management system 100 auto-scales connections as participants join and leave the meeting between the beginning and conclusion of a virtual meeting session. The transcription management system 100 implements pre-emptive connections to reduce wait time or lag to commencement of transcription when a new participant joins. The transcription management system 100 keeps connections alive in case participants become inactive (e.g., muted) and removes delays or lag in transcription when a participant becomes active (e.g., unmutes). Through active management of the pre-emptive, live connections as described herein, the transcription management system 100 achieves reduced wait time from initiation of speech to initiation of transcription. The transcription management system 100 intelligently provisions live connections to the ASR service so as to optimize or right-size the total number of live connections. In this way, the transcription management system 100 uses live connections (e.g., WebSockets) to the ASR service more efficiently than in the state of the art. Each of these features improves over the current state of real-time ASR transcription technology.

### Example Implementation of Transcription Management

FIG. 3 illustrates a data flow diagram for an example real-time meeting transcription system 300, associated with efficient, autonomous provisioning of preemptively established live connections for real-time transcription of speech in virtual meetings, and that employs the transcription management system 100. The data flow diagram shows legend 305, which is applicable to FIGS. 3, 4, 5, and 6. Real-time meeting transcription system 300 includes a virtual meeting (or collaboration) service 310, intermediate audio processing 312, a transcription socket manager 400 and an ASR service 315.

Virtual meeting service 310 is one embodiment of virtual meeting service 105. Virtual meeting service 310 is configured to host virtual meetings which may be accessed by a plurality of K discrete users 320 or participants. For example, the transcription management system 100 operates to provide captions for virtual meeting services that produce K audio streams 325 for the K discrete users 320. These individual audio streams per participant may also be referred to as “isolated audio” or “audio tracks” for the participants. K is a total number of participants in the virtual meeting. The K discrete users 320 are individually associated with a text user ID (“ID”), a text user name (“Name”), and a Boolean activity status (“Speaking”). The virtual meeting service 310 produces K audio streams 325 from the speech input by the K discrete users 320 through their respective clients of the virtual meeting service 310. Each of the K discrete users 320 is associated with one of the K audio streams 325 by user ID, for example by labeling an individual audio stream with the user ID of the user producing the audio stream. In one embodiment, the K audio streams 325 are the isolated audio streams from the K discrete users 320.

Virtual meeting service 310 may be, but is not limited to, those virtual meeting services that can natively produce isolated audio streams for individual participants, such as: Zoom, Cisco Webex, Jitsi Meet, Pexip, TrueConf, BigBlueButton. Also, virtual meeting service 310 may include, but is not limited to, those virtual meeting services that produce mixed or combined audio tracks for multiple participants, such as: Microsoft Teams, Google Meet, Slack, BlueJeans, GoToMeeting, RingCentral Video, Whereby (Appear. in), Hopin, Zoho Meeting, Discord, 8×8 Video Meetings, Tixeo, StarLeaf, Spike, Fuze, TrueConf, ClickMeeting, Eyeson, Around, Jami, Talky, Tox, Sylaps, VSee, Gruveo, Confrere, MeetFox, RemoteHQ, Krisp, Proficonf, UberConference, Blizz, Easymeeting, and Airmeet, when these services are modified by third-party plug-ins or custom solutions to produce isolated audio streams for individual participants.

At decision block 330, virtual meeting service 310 determines—for each of the K discrete users 320—whether the user is active (e.g., unmuted). The determination at decision block 330 may be based on whether the activity status (indicating that a user is speaking or otherwise unmuted) is True. Where a given user is inactive (e.g., muted) (330:NO), the audio stream associated with user is ignored 335. Where a given user is active (330:YES), the virtual meeting service 310 transmits the audio stream associated with the user out of the virtual meeting service 310 for downstream input to the ASR service 315. Decision block 330 thus filters (and ignores 335) inactive streams out of the K audio streams 325 to produce N input audio streams 340. The N input audio streams 340 are a subset of the K audio streams 325. At any given time during a virtual meeting session, there are N discrete active users participating in the virtual meeting. The value of N and the N discrete active users may vary over time, as participants of the virtual meeting become active or inactive. Thus, the audio streams in the N input audio streams 340 may change correspondingly.

Intermediate audio processing 312 is configured to modify the N input audio streams 340 from the N discrete active users. N is a total number of active participants, that is, participants who are in the meeting, and whose audio streams are not muted. The modifications to the N input audio streams 340 alter the N input audio streams 340 to make them more readily processible by transcription socket manager 400 and ASR service 315.

One audio processing step, convert to suitable chunk size 345, is configured to break or partition the audio streams into chunks, also referred to as frames or segments, covering a consistent, pre-specified length of time. In one embodiment, convert to suitable chunk size 345 produces audio chunks of a length between 0.5 and 2.0 seconds, such as chunks of 1.0 seconds. Convert to suitable chunk size 345 may be applied to one or more of the N input audio streams 340, for example, to each of the N input audio streams 340. In this way, convert to suitable chunk size 345 serves to handle continuous audio streams efficiently while minimizing latency and errors. In one embodiment, convert to suitable chunk size 345 may be optional, as ASR service 315 may include its own built-in streaming support that is configured to handle continuous audio streams.

Another audio processing step, downsample 350, is configured to reduce the sample rate of the audio streams. In one embodiment, downsample 350 reduces a higher sampling rate natively produced by the virtual meeting service 310 (such as the high-definition speech standard of 32 kHz natively produced by Zoom) to a sampling rate that is compatible for input to the ASR service 315. In one embodiment, downsample 350 is configured to resample the audio streams to a pre-specified audio sample rate. In one embodiment, downsample 350 is configured to convert the audio streams to the wideband speech sampling rate of 16 kHz. In other embodiments, downsample 350 is configured to convert the audio streams to other sampling rates, such as the telephony standard of 8 kHz or the intermediate quality standard of 22.05 kHz. In this way, downsample 350 serves to reduce computational load, focus on relevant speech frequencies (between 300 and 3400 Hz), minimize noise, lower bandwidth and storage requirements, and ensure compatibility with the ASR system. Downsample 350 may be optional, for example where the virtual meeting service produces audio at a sampling rate compatible with a supported input rate for the ASR service 315. For example, Cisco WebEx produces audio streams at 16 kHz, and OCI Realtime Speech may be configured to accept audio for processing at a sampling rate of 16 kHz.

Transcription socket manager 400 is one embodiment of transcription management system 100. Transcription socket manager 400 includes WebSocket handler 500 and UserID handler. Transcription socket manager 400 is configured to manage, in accordance with the transcription management systems and methods disclosed herein: (1) the connection between the N input audio streams 340 the ASR service 315; and (2) the diarization and speaker labeling for the transcription returned by the ASR service 315. Transcription socket manager 400 transmits individual audio streams to the ASR service 315 over the Internet 355 (or other network), and receives the transcription of the individual audio streams generated by the ASR service 315 over Internet 355, by way of a set of discrete, pre-emptively established live connections (e.g., WebSockets) to the ASR service 315. Transcription socket manager 400 thus accepts the N input audio streams 340 that are associated with user IDs, and returns output captions 360. In one embodiment, output captions 360 are transcriptions of individual audio streams labeled with speaker name, and associated with user ID. Additional detail regarding transcription socket manager 400 is provided elsewhere herein, for example under the heading “Example Socket Manager for Transcription Management.”

ASR service 315 is one embodiment of ASR service 310. ASR service 315 may be any one of a variety of services configured to accept input of an audio stream that includes speech and autonomously produce a text transcript of the words spoken. For example, ASR service 315 is an AI-based system that is configured to: (1) convert brief frames of the audio stream into acoustic features (such as spectrograms or mel-frequency cepstral coefficients) of the speech, (2) feed the acoustic features into an ML acoustic model that is trained to convert acoustic features into phonemes; (3) feed the phonemes produced by the acoustic model from the acoustic features into a ML language model that is trained to assemble phonemes into likely sequences of words based on linguistic patterns, grammar, and context; (4) feed the phonemes produced by the acoustic model and the likely sequences of words into a decoding algorithm that is configured to select a word sequence that most likely matches the speech; and (5) return the word sequence as the text transcript of the speech.

The ASR service 315 may be any of a variety of available speech recognition services, including, but not limited to: Oracle® Cloud Infrastructure (OCI) Realtime Speech, Google Cloud Speech-to-Text, Amazon Transcribe, Microsoft Azure Speech-to-Text, IBM Watson Speech-to-Text, Deepgram, Rev.ai, Otter.ai, Speechmatics, Kaldi ASR, Voci Technologies, AssemblyAI, Nuance Dragon, Soniox, Verbit, Trint, Temi, Speechly, and Agnitio (Kite Speech Recognition).

### Example Socket Manager for Transcription Management

FIG. 4 illustrates one embodiment of a transcription socket manager 400 that is associated with efficient, autonomous provisioning of preemptively established live connections for real-time transcription of speech in virtual meetings. Transcription socket manager 400 maintains a list U[ . . . ] 405 of active participants in the virtual meeting, a list W[ . . . ] 410 of available WebSocket session IDs, and a hashmap H 415 of UserID-SessionID associations. Transcription socket manager 400 performs a process for transcription management.

List U[ . . . ] 405 and list W[ . . . ] 410 are data structures, such as arrays, that are configured to hold a collection of data entities, such as text user IDs and session IDs respectively. Hashmap H 415 is a data structure, such as a table, that is configured to associate a user ID and a session ID as a tuple or pair.

Transcription socket manager 400 is configured to temporarily connect an audio stream of a participant to an independent session of the ASR service 315 while the participant is active by directing the audio stream through a WebSocket connection 450 (or other persistent live connection) to the ASR service 315 that is not currently assigned to other audio streams. And, transcription socket manager 400 is configured to associate the transcribed text received through the WebSocket connection 450 with the user ID of the participant whose audio stream is currently connected through the WebSocket connection 450.

At decision block 420, transcription socket manager 400 confirms that a UserID associated with an incoming audio stream 422 (such as one of N input audio streams 340) is present in list U[ . . . ] 405 of active speakers. (UserID handler 600 adds UserIDs to list U[ . . . ] 405 as participants become active.) Decision block 420 searches list U[ . . . ] 405 to determine whether the UserID associated with the incoming audio stream 422. If the UserID is found (420:YES), transcription socket manager 400 proceeds to decision block 425.

In one embodiment, there are M total WebSocket connections 450, each of which is either: (1) active or in use to process an input audio stream for a given user ID that is paired with the session ID for the Websocket connection in hashmap H 415; or (2) free or waiting for assignment to an audio stream, as indicated by lack of association with a user ID in hashmap H 415 and inclusion in list W[ . . . ] 410 of free WebSocket connections. The number M of WebSocket connections 450 may adjust over the course of a virtual meeting, right-sizing to accommodate variation in the participants who are active with minimal delay in transcription.

At decision block 425, transcription socket manager 400 determines whether the user ID associated with the incoming audio stream 422 is already associated in hashmap H 415 with a session ID for one of the WebSocket connections 450, or not. If the user ID for the incoming audio stream 422 is not associated with a session ID for a WebSocket connection 450 (425:NO), transcription socket manager 400 is configured to proceed to decision block 430 and begin a process to assign a WebSocket connection 450 for the incoming audio stream 422. If the user ID for the incoming audio stream 422 is already associated with a session ID for a WebSocket connection 450 (425:YES), the incoming audio stream 422 may be directed to ASR service 315 through the WebSocket connection 450 that corresponds to the session ID associated with the user ID in hashmap H 415, and transcription socket manager 400 proceeds to process block 435.

At decision block 430, transcription socket manager 400 determines whether there is a pre-emptively established WebSocket connection 450 that is free, available or otherwise not currently in use. For example, transcription socket manager queries list W[ . . . ] 410 of available WebSocket session IDs, for example requesting the session ID for the next free WebSocket connection 450 in list W[ . . . ] 410. If there is no free WebSocket connection 450 listed in list W[ . . . ] 410, as may be indicated by a null result to the query or other indication that there are no unassigned WebSockets (430:NO), transcription socket manager 400 proceeds to block 440 to create a new WebSocket connection 450 (M+1). If there is a free WebSocket connection in list W[ . . . ] 410, as may be indicated by return of a session ID for a free WebSocket connection 450 in response to the query (430:YES), transcription socket manager 400 proceeds to block 445 to assign the incoming audio stream 422 to the free WebSocket connection 450.

At process block 440, transcription socket manager 400 creates a new WebSocket connection 450 to ASR service 315, because there were no free WebSockets listed in list W[ . . . ] 410. This may occur where an unexepectedly large number (e.g., greater than count of free WebSockets C that are to be held pre-emptively in standby) of meeting participants become active (e.g., unmute) at once. For example, transcription socket manager 400 may perform the following steps to create a new WebSocket connection 450: (1) initialize a WebSocket client using a WebSocket API in a chosen programming language (e.g., JavaScript, Python); (2) establish or open a connection to a WebSocket endpoint of ASR service 315; (3) configure an event listener (e.g., an event listener component of the WebSocket client) to capture transcription results 442 from the ASR service 315, (e.g., onmessage, which will be triggered when transcription results 442 are received from the ASR service 315); (4) send initial configuration data (such as language settings, audio format/sampling rate, authentication credentials); (5) receive a session ID as a message (such as a first message) from the ASR service 315; and (6) add the received session ID to list W[ . . . ] 410 of free WebSockets. The new WebSocket connection has been pre-emptively established and is free to receive an input audio stream 422 and obtain transcription results 442 generated from the audio stream by ASR service 315. Additionally, transcription socket manager 400 may perform functions of block 440 C times to pre-emptively establish C WebSocket connections to ASR service 315 at startup, for example in response to commencement of a virtual meeting.

At process block 445, transcription socket manager 400 assigns the incoming audio stream 422 to a free WebSocket connection 450. The free WebSocket connection 450 was either identified as pre-existing in list W[ . . . ] 410 by decision block 430, or created and added to list W[ . . . ] 410 by process block 440 (where list W[ . . . ] 410 had run out of free WebSocket connections). For example, transcription socket manager 400 adds a user ID-session ID tuple or pair to hashmap H 415 of UserID-SessionID associations. The tuple includes the user ID associated with the incoming audio stream 422 and the session ID associated with the WebSocket connection 450. Adding the pair of user ID and session ID thereby assigns the incoming audio stream 422 associated with the user ID to be connected to the ASR service 315 through the WebSocket connection 450 that is associated with the session ID. This rapidly places the WebSocket connection 450 into use for transcription service, without delays to transcription commencement to allow for initialization and configuration of the WebSocket connection 450. And, transcription socket manager removes the session ID associated with the free Websocket connection 450 from W[ . . . ] 410 of available WebSocket session IDs, thereby indicating the WebSocket connection 450 is no longer free or available, and is in use. Once the connection assignment is completed, transcription socket manager 400 proceeds to sending audio at block 435.

At process block 435, transcription socket manager 400 sends incoming audio stream 422 through the assigned WebSocket connection 450, and listens for the transcription results 442 returned through the assigned WebSocket connection 450. Thus, the incoming audio stream 422 and corresponding transcription results 442 are passed to and from ASR service 315 over Internet 355 through their own, dedicated WebSocket connection 450. The WebSocket connection 450 is dedicated to one participant such that the WebSocket is allocated for sole use by the one participant. In one embodiment, a WebSocket connection (or other live connection) that is dedicated therefore carries data traffic (such as incoming audio stream 422 and transcription results 442) that is associated with the one participant alone, and which is not shared with—and excludes traffic associated with—the other participants. The transcription results 442 may be received incrementally. Transcription socket manager 400 also sends the received transcription results 442 for subsequent processing at block 455. ASR service 315 returns transcription results 442 incrementally back through the WebSocket connection 450 as the ASR service 315 generates the transcription of the input audio stream 422 arriving through the WebSocket connection 450.

By the point of transmission to the ASR service 315, the incoming audio stream 422 has been associated with the session ID of the assigned WebSocket connection 450 by the pairing in hashmap H 415 of the user ID associated with incoming audio stream 422 and the session ID of the assigned WebSocket connection 450. Because incoming audio stream 422 has been associated with the session ID of the WebSocket connection 450, transcription results received through the WebSocket connection 450 having the session ID can be accurately attributed to the user ID for the incoming audio stream 422 without reliance on diarization capabilities of ASR service 315. This logical diarization process is simpler and more accurate than diarization by the ASR service 315.

At process block 455, transcription socket manager 400 processes the received transcription results 442. Transcription socket manager 400 updates a array, string, or other data structure as a buffer that is configured for accumulating and holding the incoming text of the transcription results 442. There may be one buffer, or there may be multiple, rotating buffers. Transcription socket manager 400 listens for incoming transcription results 442. Incremental transcription results may be revised and overwritten in the buffer by subsequent incremental results based on further speech in the input audio stream 422 being processed until the results are finalized. Once a pre-determined amount of the transcription—for example, one buffer's worth of text—is finalized, transcription socket manager 400 proceeds to map the transcribed text or caption from the WebSocket connection 450 back to a user ID at block 460.

At process block 460, transcription socket manager 400 maps the session ID for the result to the user ID from hashmap H 415. Transcription socket manager 400 determines the session ID of the WebSocket connection 450 that provided the transcription results that were combined or appended to produce the finalized text at block 455. The transcription socket manager uses the session ID as a key to look up the user ID corresponding to the session ID in hashmap H 415. The resulting user ID is assigned to the finalized caption.

At process block 465, transcription socket manager 400 gets the user name associated with the user ID obtained in block 460. For example, transcription socket manager 400 may query virtual meeting service 310 for the user name corresponding to the user ID through an API endpoint of the virtual meeting service 310 (such as the get meeting participant details API of Zoom). Or, for example, transcription socket manager 400 may (1) use a listener (such as a webhook) to capture username and associated user ID of participants as they join the virtual meeting session (for example, from a meeting. participant_joined HTTP POST event produced by the virtual meeting service 310), (2) from the captured user names and user IDs, compile a searchable table or other data structure of user name—user ID associations, and (3) search the list to retireve the user name corresponding to the user ID. Or, in another example, the virtual meeting service 310 may provide a software development kit (SDK) tool that allow participant information to be accessed during a virtual meeting session, which may be used to access the user name.

At process block 460, transcription socket manager 400 appends the retrieved user name to the transcription. Transcription socket manager 400 may insert the user name in front of the finalized text of the transcript using string concatenation to enrich the transcription into output captions 360 with speaker labels. For example: “let OutputCaption=UserName+Transcript;”. Transcription socket manager 400 transmits these output captions 360 that include the user ID out as they are produced, in a real-time stream.

In one embodiment, the output captions 360 are sent back to the virtual meeting service 310. Transcription socket manager 400 injects the transcriptions back into the user interface for the virtual meeting for presentation to the participants. For example, where the transcription management system has joined the virtual meeting as a participant, the virtual meeting system may have enabled a manual captioning feature that designates the participant that is the transcription management system to be a designated captioner. output captions 360 provided by the transcription socket manager 400 are entered into the user interface for the virtual meeting and displayed to other participants in the user interface. In another example, the virtual meeting service 310 may provide an API endpoint for captioning (such as the closed captioning API or live transcription API available in Zoom). The transcription socket manager 400 requests, and virtual meeting service 310 provides an API token for captioning a given virtual meeting session. The API token includes a URL for posting text—such as the output captions 360—into the meeting in real-time. Transcription socket manager 400 may establish a further WebSocket connection to the virtual meeting service 310 at the URL, and send the output captions 360 in real-time into the virtual meeting session. Or, transcription socket manager 400 may send HTTP POST requests to the URL with the caption text in the body of the request.

WebSocket handler 500 is configured to close excess WebSocket connections to ASR service 315. Additional detail regarding WebSocket handler 500 is provided elsewhere herein, for example under the heading “Example WebSocket Handler.”

UserID handler 600 is configured to maintain list U[ . . . ] 405 of active participants, and to clean up the effects of inactive participants in list W[ . . . ] 410 and hashmap H 415. Additional detail regarding UserID handler 600 is provided elsewhere herein, for example under the heading “Example UserID Handler.”

### Example WebSocket Handler

FIG. 5 illustrates one embodiment of a WebSocket handler 500 that is associated with efficient, autonomous provisioning of preemptively established live connections for real-time transcription of speech in virtual meetings. WebSocket handler 500 determines to be excess—and consequently closes or terminates—a WebSocket when the following conditions are satisfied: (1) A total number of WebSocket connections to ASR service 315 that are ‘free’ (i.e., unassigned to a particular user) is greater than a minimum of C free WebSockets that are to be pre-emptively kept open for immediate assignment; (2) the WebSocket under consideration has been free longer than a timeout amount of time T.

In one embodiment, WebSocket handler 500 monitors each free WebSocket connection in order to determine whether the connection has become an excess connection. WebSocket handler 500 starts at block 505, and continues to process block 510. At process block 510, the WebSocket handler 500 gets the time in free state t′, which is an elapsed time since the WebSocket connection entered the “free” (or waiting/available) state. The Websocket connections are labeled with the times that they most recently became free, referred to as time freed t. The labels are updated either upon the WebSocket Connection being initiated into the free state, or upon the WebSocket connection being released from use into the free state. In one embodiment, this time may be stored in association with a session ID in list W[ . . . ] 410. Time freed t is read in, and subtracted from a current time to generate the time in free state t′. WebSocket handler 500 proceeds to decision block 515.

In one embodiment, at decision block 515, WebSocket handler 500 determines whether the WebSocket connection under consideration satisfies both of two conditions: (1) is time in free state t′ is greater than an allotted maximum T, which is a greatest amount of time that a WebSocket connection is permitted to remain in the free state; and (2) is the length of list W[ . . . ] 410 of WebSocket connections that are free (W.length) greater than a count C, which is a minimum or baseline number of WebSocket connections that are to be pre-emptively created to be available in a free state. If one or both of these conditions are unsatisfied by the WebSocket connection under consideration (515:FALSE), the WebSocket connection is considered to be within the WebSocket connections specified to be kept free for immediate use, and the WebSocket handler 500 proceeds to block 520. In one embodiment, at process block 520, WebSocket handler 500 waits for a pre-specified amount of time t0. In one embodiment, pre-specified amount of time t0 is a delay of a few minutes or less, such as 60-120 seconds.

If both of the conditions of decision block 515 are satisfied by the WebSocket connection under consideration (515:TRUE), the WebSocket connection is considered to be in excess of the WebSocket connections specified to be kept free for immediate use, and the WebSocket handler 500 proceeds to close the WebSocket connection at block 525. At process block 525, WebSocket handler 500 closes the WebSocket connection that is currently under consideration. WebSocket handler 500 then proceeds to end block 530, where WebSocket handler 500 concludes its processing. WebSocket handler 500 may repeat at intervals through the course of a virtual meeting session to ensure that excessive amounts of unused WebSocket connections are not maintained.

### Example Userid Handler

FIG. 6 illustrates one embodiment of a UserID handler 600 that is associated with efficient, autonomous provisioning of preemptively established live connections for real-time transcription of speech in virtual meetings. User ID handler 600 (1) adds users who become active to the list U[ . . . ] 405 of active users; and (2) removes from list U[ . . . ] 405 those users who have become inactive, and releases the session IDs of users who have become inactive back to list W[ . . . ] 410 of available WebSocket connections. User ID handler 600 may operate continually on a plurality of user IDs, such as on the user IDs of each participant in a virtual meeting session.

In one embodiment, user ID handler 600 monitors the user IDs to determine whether they change to active (from inactive), or change to inactive (from active). User ID handler 600 starts at block 605, and continues to process block 610. At process block 610, user ID handler 600 listens for a status change of an active status (which may also be referred to as a mute/unmute status). For example, the active status may be a Boolean variable that represents whether a participant is active (e.g., unmuted) or inactive (e.g., muted). Where the active status is TRUE, the participant is active, and where the active status is FALSE, the participant is inactive. The user ID handler 600 may listen for a webhook event indicating the change of status, such as “meeting.participant_muted”, indicating that a user has become inactive, or “meeting.participant_unmuted”, indicating that a user has become active. Or, the user ID handler 600 may regularly poll an API of the virtual meeting service to get meeting participant details that include the current mute/unmute status of individual participants, and then identify any changes to the mute/unmute status as a change event. In response to the occurrence of a change of active status for a user ID, user ID handler 600 proceeds to decision block 615.

At decision block 615, user ID handler 600 determines whether the change of active status for the user ID under consideration is (1) a change to a status of active (TRUE) from inactive (FALSE), indicating unmuting; or (2) a change to a status of inactive (FALSE) from active (TRUE), indicating muting or departure from the virtual meeting. Where the user ID has transitioned to active status (615:YES), user ID handler 600 proceeds to add the user ID to the list U[ . . . ] 405 of users that are active at process block 620. Where the user ID has transitioned to inactive status (615:NO), user ID handler 600 proceeds to remove the user ID from the list U[ . . . ] 405 of users that are active at process block 625.

At process block 620, user ID handler 600 inserts the user ID that has become active into the list U[ . . . ] 405 of users that are active. For example, user ID handler 600 (1) identifies the position in list U[ . . . ] 405 that the user ID should occupy, such as the position of the user ID among other user IDs in list U[ . . . ] 405 according to an alphanumerically sorted order of the user IDs in list U[ . . . ] 405; and (2) writes the user ID into the list U[ . . . ] 405 at the identified position. Once placed in list U[ . . . ] 405, the user ID is ready to be associated with a session ID in hashmap H 415. The user ID handler 600 then returns to block 610 and resumes monitoring for further changes to active statuses of the user IDs of virtual meeting participants.

At process block 625, user ID handler 600 removes the user ID that has become inactive from the list U[ . . . ] 405 of users that are active. For example, user ID handler 600 (1) searches list U[ . . . ] 405 for the user ID among the other user IDs in list U[ . . . ] 405; and (2) deletes the user ID from list U[ . . . ] 405. The user ID handler 600 then proceeds to process block 630 to commence further cleanup steps to dissociate an assigned WebSocket session ID from the now inactive user ID, and place the session ID for the freed WebSocket back into the pool of free WebSockets in list W[ . . . ] 410.

At process block 630, user ID handler 600 removes the user ID and its associated session ID from hashmap H 415. For example, at process block 630, user ID handler 600 (1) searches hashmap H 415 for the user ID among the other user IDs in hashmap H 415; (2) retrieves the session ID that is associated with the user ID in hashmap H 415 for return to list W[ . . . ] 410; and (3) deletes the user ID and corresponding session ID from hashmap H 415. The user ID handler 600 then proceeds to process block 635.

At process block 635, user ID handler 600 adds the session ID retrieved from hashmap H 415 back into list W[ . . . ] of available WebSocket connections. For example, user ID handler 600 (1) identifies the position in list W[ . . . ] 410 that the session ID should occupy, such as the position of the session ID among other session IDs in list W[ . . . ] 410 according to an alphanumerically sorted order of the session IDs in list W[ . . . ] 410; and (2) writes the session ID into the list W[ . . . ] 410 at the identified position. The cleanup procedure thus concludes, and the user ID handler 600 then returns to block 610 where it resumes monitoring for further changes to active statuses of the user IDs of virtual meeting participants.

### Example Improvements

The transcription management system 100 is distinct from any prior virtual meeting transcription at least as follows. To conserve resources for live connections, virtual meeting services may attempt to use a single live connection between the virtual meeting and the ASR service for meeting-level transcription, which is prone to diarization errors and to multiple speakers or noise obscuring speech. Attempts to overcome these challenges with participant-level transcription in which separate speaker audio streams are each provided their own permanently dedicated live connection consumes excessive compute resources. Attempts to add live connections in response to participants becoming active fails to capture initial speech by the newly active participants while the live connections are being established. In one embodiment, these and other technical problems with ASR live transcription are resolved by the transcription management system 100.

In one improvement to the technology of ASR transcription, the transcription management system 100 increases privacy and trust in the automated transcription service. With increasing needs of privacy and information regulation, organizations may desire to use their own secured, trusted services for transcribing or captioning communication which may contain sensitive information. This could include live and recorded meetings, voicemails, emails, messages, and so on.

In another improvement to the technology of ASR transcription, the transcription management system 100 allows for transcription from a client or participant of a virtual meeting, rather than from a central server for the virtual meeting. In this way, the meeting may be transcribed live, in real-time, even in the case where the server of the virtual meeting is not configured to provide transcription.

In another improvement to the technology of ASR transcription, the transcription management system 100 reduces (for example, practically eliminates) diarization errors, such as misattribution of transcribed speech to the wrong speaker. Providing separate diarized transcriptions for individual participants of a virtual meeting presents challenges, such as contemporaneous speech by multiple participants (e.g., participants talking over each other), and accurate distinguishing of a voice of one speaker from a voice of another. Direct audio capturing and transcribing using a single stream of audio for multiple participants of a virtual meeting will give transcription results where the captions cannot easily be identified to a particular speaker. Even in cases where the ASR service supports speaker diarization, there is high possibility of inaccurate diarization, and diarization may become impossible if the number of meeting participants is large. The transcription management system 100 resolves these challenges by providing isolated audio streams of individual speakers to the ASR service. The transcription management system 100 distinguishes speakers structurally, directing audio streams of individual speakers to separate connections to the ASR service. This yields a substantial reduction in resources consumed, as well as a substantial increase in accuracy, over artificial intelligence (AI)/machine learning (ML) voice analysis (e.g., speaker embeddings) for diarization on the transcript.

In another improvement to the technology of ASR transcription, the transcription management system 100 automatically and accurately identifies and labels the speaking participants on transcripts. Even with diarized results, it is a non-trivial computing problem to identify which participant maps to which diarized caption. The transcription management system 100 identifies speaking participants and labels transcripts with speakers using database and logical operations, rather than AI/ML operations. This yields a substantial reduction in resources consumed for labeling and identification on the transcript, and increases accuracy of identification and labeling over AI/ML techniques.

In another improvement to the technology of ASR transcription the transcription management system 100 automates capacity planning for transcription resources over the course of the virtual meeting, thereby enhancing operational efficiency of resource utilization and management. It is common for participants to join and leave the virtual meeting session during the course of the meeting. If there is an influx or outflux of participants, handling transcription for each participant can be difficult to manage. Where the number of meeting participants is large, the transcription of each of the participants can consume excessive compute resources, which affects both the latency and quality of captions. However, the number of participants that are active and contributing to the virtual meeting in a given range of time is generally substantially fewer than the total number of meeting participants. The transcription management system 100 therefore resolves the resource challenges by (i) tuning or adjusting a quantity of pre-emptively established live streaming (e.g., WebSocket) connections to the ASR service over the course of the virtual meeting to accommodate isolated audio processing for a portion of the participants that might become active at any one time, and (ii) automatically allocates the connections among the participants based on a participant becoming active or inactive.

The transcription management system 100 also improves the technology of ASR transcription in a variety of other ways, as described elsewhere herein.

### Cloud or Enterprise Embodiments

In one embodiment, the present system (such as transcription management system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, transcription management system 100 is a centralized server-side application that provides at least the functions disclosed herein and that is accessed by many users by way of computing devices/terminals communicating with the computers of transcription management system 100 (functioning as one or more servers) over a computer network. In one embodiment transcription management system 100 may be implemented by a server or other computing device configured with hardware and software to implement the functions and features described herein.

In one embodiment, the components of transcription management system 100 may be implemented as sets of one or more software modules executed by one or more computing devices specially configured for such execution. In one embodiment, the components of transcription management system 100 are implemented on one or more hardware computing devices or hosts interconnected by a data network. For example, the components of transcription management system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of transcription management system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of transcription management system 100 may (i) generate or compose an electronic message or signal to issue a command or request to another component, (ii) transmit the message or signal to other components of transcription management system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by transcription management system 100, for example through a web interface server. In one embodiment, the remote computing system may send requests to and receive responses from transcription management system 100. In one example, access to the information or applications may be effected through use of a web browser on a personal computer or mobile device. In one example, communications exchanged with transcription management system 100 may take the form of remote representational state transfer (REST) requests using JavaScript object notation (JSON) as the data interchange format for example, or simple object access protocol (SOAP) requests to and from XML servers. The REST or SOAP requests may include API calls to components of transcription management system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### Computing Device Embodiment

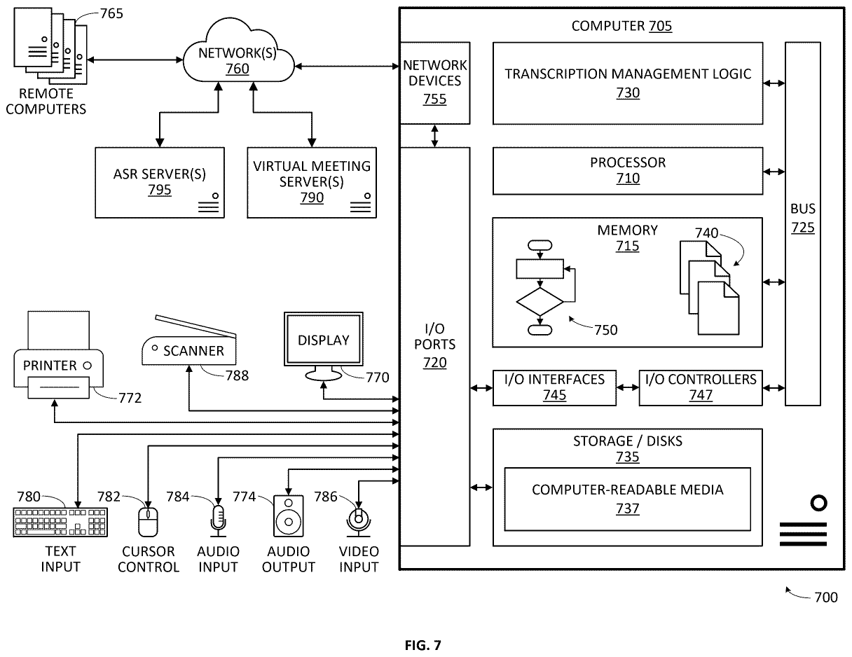

FIG. 7 illustrates an example computing system 700 that is configured and/or programmed as a special purpose computing device(s) with one or more of the example systems and methods described herein, and/or equivalents. The example computing device may be a computer 705 that includes at least one hardware processor 710, a memory 715, and input/output ports 720 operably connected by a bus 725. In one example, the computer 705 may include transcription management logic 730 configured to facilitate efficient, autonomous provisioning of preemptively established live connections for real-time transcription of speech in virtual meetings, similar to the logic, systems, methods and other embodiments shown in and described with reference to FIGS. 1-6 herein.

In different examples, the logic 730 may be implemented in hardware, one or more non-transitory computer-readable media 737 with stored instructions, firmware, and/or combinations thereof. While the logic 730 is illustrated as a hardware component attached to the bus 725, it is to be appreciated that in other embodiments, the logic 730 could be implemented in the processor 710, stored in memory 715, or stored in disk 735.

In one embodiment, logic 730 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate efficient, autonomous provisioning of preemptively established live connections for real-time transcription of speech in virtual meetings. The means may also be implemented as stored computer executable instructions that are presented to computer 705 as data 740 that are temporarily stored in memory 715 and then executed by processor 710.

Logic 730 may also provide means (e.g., hardware, non-transitory computer-readable medium that stores executable instructions, firmware) for performing one or more of the disclosed functions and/or combinations of the functions.

Generally describing an example configuration of the computer 705, the processor 710 may be a variety of various processors including dual microprocessor and other multi-processor architectures. A memory 715 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 735 may be operably connected to the computer 705 via, for example, an input/output (I/O) interface (e.g., card, device) 745 and an input/output port 720 that are controlled by at least an input/output (I/O) controller 747. The disk 735 may be, for example, a magnetic disk drive, a solid-state drive, a floppy disk drive, a tape drive, a Zip drive, a flash memory card, a memory stick, and so on. Furthermore, the disk 735 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 715 can store a process 750 and/or a data 740, for example. The disk 735 and/or the memory 715 can store an operating system that controls and allocates resources of the computer 705.

The computer 705 may interact with, control, and/or be controlled by input/output (I/O) devices via the input/output (I/O) controller 747, the I/O interfaces 745, and the input/output ports 720. Input/output devices may include, for example, one or more network devices 755, displays 770, printers 772 (such as inkjet, laser, or 3D printers), audio output devices 774 (such as speakers or headphones), text input devices 780 (such as keyboards), cursor control devices 782 for pointing and selection inputs (such as mice, trackballs, touch screens, joysticks, pointing sticks, electronic styluses, electronic pen tablets), audio input devices 784 (such as microphones or external audio players), video input devices 786 (such as video and still cameras, or external video players), image scanners 788, video cards (not shown), disks 735, and so on. The input/output ports 720 may include, for example, serial ports, parallel ports, and USB ports.

The computer 705 can operate in a network environment and thus may be connected to the network devices 755 via the I/O interfaces 745, and/or the I/O ports 720. Through the network devices 755, the computer 705 may interact with a network 760. Through the network 760, the computer 705 may be logically connected to remote computers 765. Networks with which the computer 705 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User” (and “participant”), as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
preemptively establish a set of live connections to an automatic speech recognition service that are available for use, wherein the set of live connections includes fewer live connections than a total K of participants in a virtual meeting;
in response to a participant of the virtual meeting becoming active, dedicate one live connection from the set of live connections to real-time transcription of an individual audio stream from the participant;
in real-time, label transcription results received back through the one live connection with a username of the participant; and
in real-time, inject the labeled transcription results back into the virtual meeting for display in a user interface of the virtual meeting.

2. The one or more non-transitory computer-readable media of claim 1, wherein the instructions, when executed by the processor, cause the computing system to:
monitor a mute/unmute status of the participant to determine when the participant becomes active;
in response to the mute/unmute status changing from mute to unmute, allocate the one live connection for sole use by the participant and connect the individual audio through the one live connection to an individual session of the automatic speech recognition service; and
in response to the mute/unmute status changing from unmute to mute, disconnect the individual audio stream from the one live connection, and deallocate the one live connection back to the set of live connections that are available for use.

3. The one or more non-transitory computer-readable media of claim 1, wherein the instructions to dedicate one live connection from the set of live connections to real-time transcription of the individual audio stream from the participant, when executed by at least the processor, cause the computing system to:
associate a session ID of the one live connection with a user ID of the participant; and
send the individual audio stream of the participant to the automatic speech recognition service through the one live connection to cause the automatic speech recognition service to transcribe speech from the individual audio stream into the transcription results in real-time, wherein audio streams of other participants are not sent through the one live connection.

4. The one or more non-transitory computer-readable media of claim 1, wherein the instructions to preemptively establish the set of live connections to the automatic speech recognition service, when executed by at least the processor, cause the computing system to, prior to the participant becoming active, for at least the one live connection in the set of live connections:
connect a client to an endpoint of the automatic speech recognition service;
configure the client to capture the transcription results upon receipt from the automatic speech recognition service;
transmit credentials for the client to the automatic speech recognition service;
receive a session ID for the one live connection, wherein the session ID denotes an individual session of the automatic speech recognition service that is accessible through the one live connection; and
add the session ID for the one live connection to a list of session IDs for the set of live connections.

5. The one or more non-transitory computer-readable media of claim 1, further comprising instructions that when executed by at least the processor cause the computing system to close live connections that are in excess of a baseline count C of live connections and which have been available for use longer than a threshold amount of time T.

6. The one or more non-transitory computer-readable media of claim 1, further comprising instructions that when executed by at least the processor cause the computing system to expand the set of live connections to the automatic speech recognition service by preemptively establishing additional live connections when the live connections that are available for use falls to a threshold number.

7. The one or more non-transitory computer-readable media of claim 1, wherein the live connections to the automatic speech recognition service are WebSocket connections.

8. A computer-implemented method, comprising:
preemptively establishing a set of live connections to an automatic speech recognition service that are available for use, wherein the set of live connections includes fewer live connections than a total K of participants in a virtual meeting;
in response to a participant of the virtual meeting becoming active, dedicate one live connection from the set of live connections to real-time transcription of an individual audio stream from the participant;
in real-time, labeling transcription results received back through the one live connection with a username of the participant; and
in real-time, injecting the labeled transcription results back into the virtual meeting for display in a user interface of the virtual meeting.

9. The computer-implemented method of claim 8, further comprising
associating a session ID of the one live connection with a user ID of the participant; and
sending the individual audio stream of the participant to the automatic speech recognition service through the one live connection to cause the automatic speech recognition service to transcribe speech from the audio stream into the transcription results in real-time, wherein audio streams of other participants are not sent through the one live connection.

10. The computer-implemented method of claim 8, further comprising, in response to the participant of the virtual meeting becoming inactive, releasing the one live connection from dedication to the participant back into the set of live connections that are available for use.

11. The computer-implemented method of claim 8, further comprising closing live connections that are in excess of a baseline count C of live connections and which have been available for use longer than a threshold amount of time T.

12. The computer-implemented method of claim 8, further comprising expanding the set of live connections to the automatic speech recognition service by preemptively establishing additional live connections when the live connections that are available for use falls to a threshold number.

13. The computer-implemented method of claim 8, wherein the participant is considered active when the audio stream of the participant is unmuted, and wherein the participant is considered inactive when the audio stream of the participant is muted.

14. The computer-implemented method of claim 8, wherein the real-time transcription includes translation from a first human language to a second human language, wherein speech in the individual audio stream is in the first human language, and the transcription results are in the second human language.

15. A computing system, comprising:
at least one processor connected to at least one memory;
one or more non-transitory computer-readable media that include stored thereon computer-executable instructions that when executed by at least a processor of the computing system cause the computing system to:
preemptively establish a set of WebSocket connections to an automatic speech recognition service that are available for use, wherein the set of WebSocket connections includes fewer WebSocket connections than a total K of participants in a virtual meeting;
in response to a participant of the virtual meeting becoming active, dedicate one WebSocket connection from the set of WebSocket connections to real-time transcription of an individual audio stream from the participant;
in real-time, label transcription results received back through the one WebSocket connection with a username of the participant; and
in real-time, inject the labeled transcription results back into the virtual meeting for display in a user interface of the virtual meeting.

16. The computing system of claim 15, wherein the instructions to dedicate the one WebSocket connection from the set of WebSocket connections to the real-time transcription of the individual audio stream from the participant, when executed by at least the processor, cause the computing system to:
associate a session ID of the one WebSocket connection with a user ID of the participant; and
send the individual audio stream of the participant to the automatic speech recognition service through the one WebSocket connection to cause the automatic speech recognition service to transcribe speech from the audio stream into the transcription results in real-time, wherein audio streams of other participants are not sent through the one WebSocket connection.

17. The computing system of claim 15, wherein the instructions, when executed by at least the processor, cause the computing system to, in response to the participant of the virtual meeting becoming inactive, release the one WebSocket connection from dedication to the participant back into the set of WebSocket connections that are available for use.

18. The computing system of claim 15, wherein the instructions, when executed by at least the processor, cause the computing system to close WebSocket connections that are in excess of a baseline count C of WebSocket connections and which have been available for use longer than a threshold amount of time T.

19. The computing system of claim 15, wherein the instructions, when executed by at least the processor, cause the computing system to expand the set of WebSocket connections to the automatic speech recognition service by preemptively establishing additional WebSocket connections when the WebSocket connections that are available for use falls to a threshold number.

20. The computing system of claim 15, wherein the instructions, when executed by at least the processor, cause the computing system to join the virtual meeting as an additional participant to obtain the individual audio stream input by the participant.
